(19) United States
(12) Patent Application Publication
(10) Pub. No.: US 2011/0117396 A1
(43) Pub. Date: May 19, 2011

(54) Battery Pack and Method of Preventing Cap Disassembly or Cell Replacement in the Battery Pack

(75) Inventors: Jong-Woon Yang, Yongin-si (KR); Susumu Segawa, Yongin-si (KR); In-Kyu Park, Yongin-si (KR); Tetsuya Okada, Yongin-si (KR); Eui-Jeong Hwang, Yongin-si (KR); Se-Sub Sim, Yongin-si (KR); Jin-Wan Kim, Yongin-si (KR); Han-Seok Yun, Yongin-si (KR); Beom-Gyu Kim, Yongin-si (KR)

(73) Assignee: Samsung SDI Co., Ltd., Yongin-si (KR)

(21) Appl. No.: 12/845,642

(22) Filed: Jul. 28, 2010

(30) Foreign Application Priority Data
Nov. 18, 2009 (KR) 10-2009-0111541

(51) Int. Cl. H01M 2/00

(52) U.S. Cl. 429/50; 429/61

(57) ABSTRACT

A battery pack having a function for preventing operation of the battery pack when an abnormal replacement of a battery cell is detected or preventing a use of the battery pack in which a cap has been removed. The battery pack generates an encryption code and writes the encryption code to data flash when a battery cell is normally discharged according to a first voltage, and if an abnormal power-on reset is detected on the battery cell, the battery pack may check the stored encryption code to a second encryption code generated upon power-on reset. If the codes do not match, firmware of the battery pack is deleted and/or a fuse is blown, making it is possible to prevent the battery pack from being re-used when the battery cell has been replaced or in which a cap has been removed.

### CLAIM OF PRIORITY

This application makes reference to, incorporates the same herein, and claims all benefits accruing under 35 U.S.C §119 from an application entitled BATTERY PACK, AND METHOD OF PREVENTING CAP DISASSEMBLY IN BATTERY PACK earlier filed in the Korean Industrial Property Office on Nov. 18, 2009, and there duly assigned Serial No. 10-2009-0111541 by that Office.

### BACKGROUND OF THE INVENTION

1. Field of the Invention

One or more embodiments of the present invention relate to a battery pack, and more particularly, to a method of preventing re-use of a battery pack in which only battery cells in the battery pack have been replaced.

2. Description of the Related Art

Research related to rechargeable batteries has been actively conducted in correspondence with development of portable electronic devices, such as cellular phones, notebook computers, camcorders, personal digital assistants (PDAs) and the like. In particular, with respect to such rechargeable batteries, various types including a nickel-cadmium battery, a lead acid battery, a nickel metal hydride battery (NiMH), a lithium ion battery, a lithium polymer battery, a metal lithium battery, a zinc-air battery or the like have been developed. The rechargeable batteries are combined with a circuit so as to form a battery pack, and recharged and discharged via an external terminal of the battery pack.

A conventional battery pack includes a battery cell and a peripheral circuit including a charge-discharge circuit. This peripheral circuit is formed as a printed circuit board (PCB), and then is combined with the battery cell. When an external power supply is connected to an external terminal of the battery pack, the battery cell is charged by the external power supplied via the external terminal and the charge-discharge circuit, and when a load is connected to the external terminal, power from the battery cell is supplied to the load via the charge-discharge circuit and the external terminal. Here, the charge-discharge circuit controls charge and discharge of the battery cell occurring between the external terminal and the battery cell.

Meanwhile, the conventional battery pack has a problem in that it is not possible to prevent abnormal use of the battery pack since it is possible to re-use the battery pack by removing a protective cap and then replacing only the battery cell.

### SUMMARY OF THE INVENTION

One or more embodiments of the present invention include a battery pack having a function for preventing operation of the battery pack when an abnormal replacement of a battery cell is detected.

One or more embodiments of the present invention include a method of preventing a use of a battery pack in which a cap has been removed in a battery pack.

Additional aspects will be set forth in part in the description which follows and, in part, will be apparent from the description, or may be learned by practice of the presented embodiments.

According to one or more embodiments of the present invention, a battery pack includes a voltage determining unit for determining whether a battery cell voltage of a battery cell is equal to or less than a first voltage; an encryption code generating unit for generating a first encryption code according to information of the battery cell when the battery cell voltage is equal to or less than the first voltage; and a control unit for writing the first encryption code to an area of a data flash, checking whether the first encryption code and a second encryption code, generated by using the information of the battery cell after a power-on reset, match with each other, and prohibiting operation of the battery pack when the first encryption code and the second encryption code do not match with each other.

The voltage determining unit may determine whether the battery cell voltage of the battery cell, after the power-on reset, is equal to or greater than a second voltage, and when the battery cell voltage is equal to or greater than the second voltage, the encryption code generating unit may generate the second encryption code according to the information of the battery cell, and the control unit may check whether the first encryption code and the second encryption code match with each other.

The control unit may blow a fuse when the first encryption code and the second encryption code do not match with each other.

The control unit may delete firmware when the first encryption code and the second encryption code do not match with each other.

The control unit may turn a power off when the battery cell voltage is equal to or less than the first voltage.

The information of the battery cell may include at least one of the group consisting of a production date, a serial number, a full charge capacity (FCC), and a cycle count.

According to one or more embodiments of the present invention, a battery pack includes a battery cell, and a protective circuit including an analog front end (AFE), a charge-discharge switch, a fuse, and a microcomputer, wherein the microcomputer includes a voltage determining unit for determining whether a battery cell voltage detected by the AFE is equal to or less than a first voltage; an encryption code generating unit for generating a first encryption code by using information of the battery cell when the battery cell voltage is equal to or less than the first voltage, wherein the information includes at least one of the group consisting of a production date, a serial number, a full charge capacity (FCC), and a cycle count of the battery cell; and a control unit for writing the first encryption code to an area of a data flash, checking whether the first encryption code and a second encryption code generated by using the information of the battery cell after a power-on reset match with each other, and prohibiting operation of the battery pack when the first encryption code and the second encryption code do not match with each other.

The control unit may blow the fuse when the first encryption code and the second encryption code do not match with each other.

The control unit may delete firmware of the microcomputer when the first encryption code and the second encryption code do not match with each other.

The control unit may turn off the protective circuit when the battery cell voltage is equal to or less than the first voltage.

According to one or more embodiments of the present invention, a method of preventing a use of a battery pack in which only a battery cell has been removed in a battery pack including a battery cell, and a protective circuit including an analog front end (AFE), a charge-discharge switch, a fuse, and a microcomputer, the method includes the operations of determining whether a battery cell voltage of a battery cell is equal to or less than a first voltage; when the battery cell voltage is equal to or less than the first voltage, generating a first encryption code according to information of the battery cell; writing the first encryption code to an area of a data flash; checking whether the first encryption code and a second encryption code generated by using the information of the battery cell match after a power-on reset match with each other; and when the first encryption code and the second encryption code do not match with each other, prohibiting operation of the battery pack.

The operation of checking may include the operations of determining whether the battery cell voltage of the battery cell after the power-on reset is equal to or greater than a second voltage; when the battery cell voltage is equal to or greater than the second voltage, generating the second encryption code according to the information of the battery cell; and checking whether the first encryption code and the second encryption code match with each other.

The operation of prohibiting may include the operation of deleting firmware of the microcomputer.

The operation of prohibiting may further include the operation of blowing the fuse.

The information of the battery cell may include at least one of the group consisting of a production date, a serial number, a full charge capacity (FCC), and a cycle count.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a circuit diagram of a battery pack according to an embodiment of the present invention;

FIG. 2 is a block diagram of a microcomputer illustrated in FIG. 1;

FIG. 3 is a flowchart of a method of preventing cap disassembly or battery cell replacement in a battery pack, according to an embodiment of the present invention; and

FIG. 4 is a flowchart of a method of preventing cap disassembly or battery cell replacement in a battery pack, according to another embodiment of the present invention.

### DETAILED DESCRIPTION OF THE INVENTION

Reference will now be made in detail to embodiments, examples of which are illustrated in the accompanying drawings, wherein like reference numerals refer to the like elements throughout. In the following description, well-known functions or constructions are not described in detail since they would obscure the embodiments with unnecessary detail.

Also, terms or words used in the following description should not be construed as being limited to common or general meanings but should be construed as fully satisfying the concept of the embodiments. As used herein, the term “and/or” includes any and all combinations of one or more of the associated listed items.

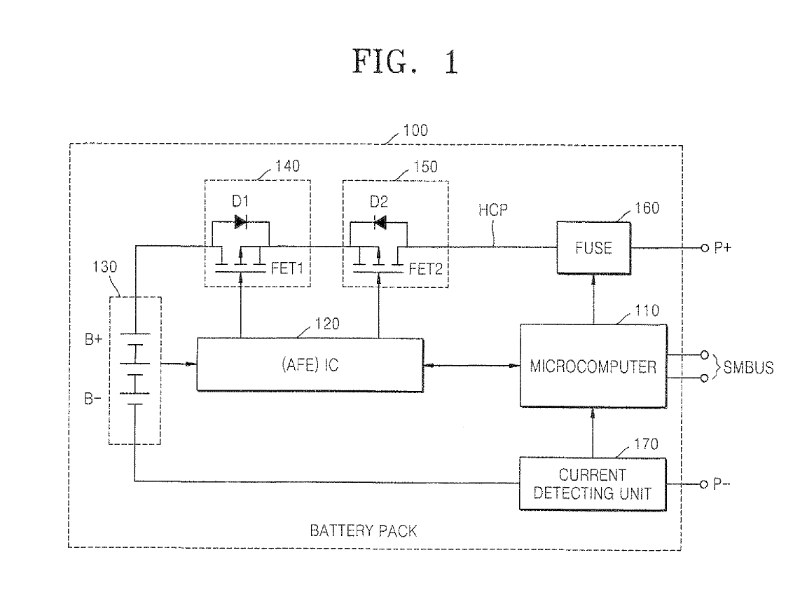

FIG. 1 is a circuit diagram of a battery pack 100 according to an embodiment of the present invention.

Referring to FIG. 1, the battery pack 100 according to the present embodiment includes a battery cell 130 that is rechargeable, and a protective circuit (110, 170), and is mounted in an external system such as a portable notebook or a personal computer (PC), and therein the battery cell 130 is charged or discharged.

The battery pack 100 includes the battery cell 130, an external terminal (not shown) connected in parallel with the battery cell 130, a charge device 140 and a discharge device 150 which are connected in series in a high current path (HCP) between the battery cell 130 and the external terminal, a fuse 160 connected in series in a high current path between the discharge device 150 and the external terminal, an analog front end (hereinafter, referred to ‘AFE’) integrated circuit (IC) 120 connected in parallel with the battery cell 130, the charge device 140, and the discharge device 150, and the protective circuit including a microcomputer 110 having one end connected to the AFE IC 120 and having another end connected to the fuse 160. The protective circuit of the battery pack 100 further includes a current detecting unit 170 that is connected in series in the high current path between the battery cell 130 and the external terminal and that is also connected to the microcomputer 110.

In addition, the battery pack 100 may further include a self protection control device (not shown) for blowing the fuse 160 by a control of the microcomputer 110 or by a control of the external system (not shown). When it is determined by the microcomputer 110 that the battery cell 130 is over-charged or over-discharged, the microcomputer 110 prevents over-charge and over-discharge of the battery cell 130 by turning off the charge device 140 and the discharge device 150 or by blowing the fuse 160. That is, when the microcomputer 110 determines that the battery cell 130 is in an over-charged or over-discharged state, the microcomputer 110 outputs a corresponding control signal, and may then blow the fuse 160 via a control switch (not shown) and a heater (not shown).

The battery pack 100 is charged or discharged by being connected to the external system (not shown) via the external terminal. The high current path between the battery cell 130 and the external terminal is used as a charge-discharge path, and relatively high current flows through the high current path. The battery pack 100 further includes a system management BUS (SMBUS) between the microcomputer 110 of the protective circuit and the external terminal so as to perform communication with the external system.

Here, the external system connected to the battery pack 100 via the external terminal may be a portable electronic device, e.g., a portable notebook computer, that may be powered by an adaptor connected to a power supply. In this regard, when the external system is connected to the adaptor, the external system may operate using the adaptor, and the adaptor may supply power to the battery cell 130 through the high current path between the battery cell 130 and the external terminal so as to charge the battery cell 130. When the external system is separated from the adaptor, the battery cell 130 may be discharged by supplying power to a load of the external system via the external terminal. That is, when the external system is connected to the adaptor, a charging operation occurs, and a charging path thereof reaches the battery cell 130 via the external terminal, the discharge device 150, and the charge device 140. When the adaptor is separated from the external system, and the load of the external system is connected to the external terminal, a discharging operation occurs, and a discharging path thereof reaches the load of the external system from the battery cell 130 via the charge device 140, the discharge device 150, and the external terminal. Here, the battery cell 130 is a chargeable and dischargeable secondary battery cell.

In FIG. 1, B+ and B− indicate power sources of both end terminals of battery cells that are connected in series. The battery cell 130 outputs cell related information to the AFE IC 120, which will be described below, wherein the cell related information includes a cell temperature, a cell charge voltage, and an amount of current flowing in the battery cell 130.

The charge device 140 and the discharge device 150 are connected in series in the high current path between the external terminal and the battery cell 130, and respectively charges and discharges the battery pack 100. Each of the charge device 140 and the discharge device 150 is formed of a field effect transistor (FET) and a parasitic diode (hereinafter, referred to as ‘diode D1’or ‘diode D2’). That is, the charge device 140 is formed of a transistor FET1 and a diode D1, and the discharge device 150 is formed of a transistor FET2 and a diode D2.

A connecting direction between a source and a drain of the transistor FET1 of the charge device 140 is set to be inverse to that of the transistor FET2 of the discharge device 150. According to this structure, the transistor FET1 of the charge device 140 is connected to restrict a current flow from the external terminal to the battery cell 130 while the transistor FET2 of the discharge device 150 is connected to restrict a current flow from the battery cell 130 to the external terminal. Here, the transistor FET1 and the transistor FET2 of the charge device 140 and the discharge device 150 are switching devices. However, the scope of one or more embodiments is not limited thereto, and thus may include an electric device for performing other kinds of switching functions. In addition, the diode D1 and the diode D2 included in the charge device 140 and the discharge device 150 are respectively configured to allow a current to flow in a direction inverse to a direction in which a current flow is restricted by a respective FET.

The AFE IC 120 is connected in parallel between the battery cell 130, and the charge device 140 and the discharge device 150, and is connected in series between the battery cell 130 and the microcomputer 110, which will be described below. The AFE IC 120 measures a voltage of the battery cell 130, transfers the measurement to the microcomputer 110, and controls operation of the charge device 140 and the discharge device 150 according to a control of the microcomputer 110.

In more detail, when the external system, which is connected to the battery pack 100, is connected to the adaptor, the AFE IC 120 turns the transistor FET1 of the charge device 140 on and turns the transistor FET2 of the discharge device 150 off, thereby allowing the battery cell 130 to be charged. Similarly, when the load of the external system is connected to the battery cell 130, the AFE IC 120 turns the transistor FET1 of the charge device 140 off and turns the transistor FET2 of the discharge device 150 on, thereby allowing the battery cell 130 to be discharged.

The microcomputer 110 is an IC connected in series between the AFE IC 120 and the external system, and functions to prevent over-charge, over-discharge, and an over-current of the battery cell 130 by controlling the charge device 140 and the discharge device 150 via the AFE IC 120. That is, the microcomputer 110 compares the voltage of the battery cell 130, which is measured by and received from the AFE IC 120, with a voltage level value that is internally set, outputs a control signal to the AFE IC 120 according to a result of the comparison, turns the charge device 140 and the discharge device 150 on or off accordingly, and thus prevents over-charge, over-discharge, and an over-current of the battery cell 130.

In more detail, if the voltage of the battery cell 130, which is transferred to the microcomputer 110, is equal to or greater than an internally set over-charge level voltage value, e.g., about 4.35V, the microcomputer 110 determines that the battery cell 130 is in an over-charged state, outputs a corresponding control signal to the AFE IC 120, and then turns the transistor FET1 of the charge device 140 off. Thus, charging of the battery cell 130 due to the adaptor of the external system is blocked. Here, the diode D1 of the charge device 140 functions to allow a discharge function of the battery pack 100 to be performed even when the transistor FET 1 of the charge device 140 is turned off. Conversely, if the voltage of the battery cell 130, which is transferred to the microcomputer 110, is equal to or less than an internally set over-discharge level voltage value, e.g., about 2.30V, the microcomputer 110 determines that the battery cell 130 is in an over-discharged state, outputs a corresponding control signal to the AFE IC 120, and then turns the transistor FET2 of the discharge device 150 off. Thus, discharging of the battery cell 130 due to the load of the external system is blocked. Here, the diode D2 of the discharge device 150 functions to allow a charge function of the battery pack 100 to be performed even when the transistor FET2 of the discharge device 150 is turned off.

In the present embodiment, when the microcomputer 110 determines that the voltage of the battery cell 130 is in a low voltage state, e.g., a voltage equal to or less than a battery minimum voltage, the microcomputer 110 enters a shut down mode and then turns the microcomputer 110 off. For example, when the voltage of the battery cell 130, which is transmitted from the AFE IC 120 is equal to or less than about 2.30V, the microcomputer 110 is turned off. Here, when a charge voltage is applied to the battery cell 130, the microcomputer 110 is normally reset. However, if the battery cell 130 is forcibly replaced or removed, when a charge voltage is applied to the battery cell 130 and then the microcomputer 110 is reset, this is an abnormal power-on reset. Thus, in order to detect such an abnormal reset, the microcomputer 110 detects a voltage of the battery cell 130 after a reset, and then determines that an abnormal power-on reset has occurred when the voltage detected is equal to or less than a predetermined voltage, e.g., about 3.0V. Thus, according to the present embodiment, by detecting an abnormal power-on reset, it is possible to prevent a case in which a cap of the battery pack 100 is disassembled or a case in which the battery pack 100 is used when only the battery cell 130 is replaced.

In addition, the microcomputer 110 has a function to communicate with the external system via the SMBUS. That is, the microcomputer 110 receives information including the voltage of the battery cell 130 or the like from the AFE IC 120, and delivers the information to the external system. Here, the information of the battery cell 130 is synchronized with a clock signal of a clock line of the SMBUS, and then is delivered to the external system via a data line.

The current detecting unit 170 may detect a current of the battery pack 100. Information about the current detected by the current detecting unit 170 is input to the microcomputer 110. If an over-current flows through the battery pack 100, the microcomputer 110 outputs a control signal for blocking a current flow and then turns off the charge device 140 and the discharge device 150, or blows the fuse 160, thereby blocking a over-current state of the battery pack 100.

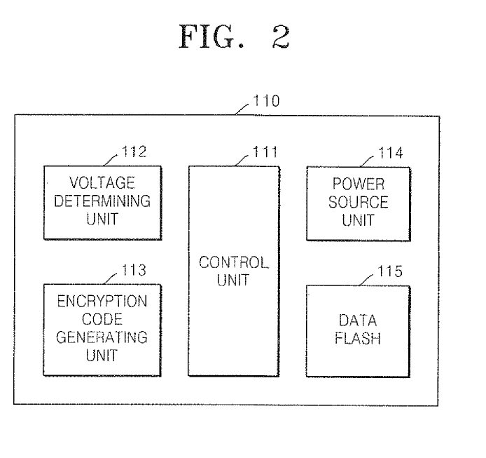

FIG. 2 is a block diagram of the microcomputer 110 illustrated in FIG. 1.

Referring to FIG. 2, the microcomputer 110 includes a control unit 111, a voltage determining unit 112, an encryption code generating unit 113, a power source unit 114, and a data flash (memory) 115.

The voltage determining unit 112 determines whether the voltage of the battery cell 130 is equal to or less than a first voltage. Here, the first voltage is a minimum voltage of the battery cell 130, indicates a voltage level value which is output from the AFE IC 120, and is a voltage at which the microcomputer 110 enters the shut down mode. For example, in cases where the minimum voltage of the battery cell 130 is equal to or less than about 2.30V, the microcomputer 110 is turned off.

The encryption code generating unit 113 generates a first encryption code according to the information of the battery cell 130, when the voltage of the battery cell 130 which is determined by the voltage determining unit 112 is equal to or less than the first voltage. Also, when the voltage of the battery cell 130 is measured after the reset and is equal to or greater than the predetermined voltage, that is, when the voltage of the battery cell 130 is equal to or greater than voltages corresponding to an abnormal power-on reset, the encryption code generating unit 113 generates an encryption code again according to the information of the battery cell 130. Here, the information of the battery cell 130 may include a production date, a serial number, a full charge capacity (FCC), and a cycle count, and the encryption code is generated by combining the production date, the serial number, the full charge capacity (FCC), and the cycle count. The cycle count is incremented whenever a battery discharge amount becomes equal to or greater than 90% of an initially designed discharge capacity, and is used to inform the number of times that the battery cell 130 has been used.

The control unit 111 writes the first encryption code, which is generated by the encryption code generating unit 113, to an area of the data flash 115. That is, in the case where the battery cell 130 is normally discharged, the control unit 111 controls the encryption code generating unit 113 to generate an encryption code when the voltage of the battery cell 130 is equal to or less than the predetermined voltage, and writes the encryption code to the area of the data flash 115. After that, when the battery cell 130 is charged or the battery cell 130 is replaced, the control unit 111 checks the encryption code written to the data flash 115, and thus prevents an abnormal use of the battery pack 100 or a case in which the cap of the battery pack 100 has been disassembled and then the battery pack 100 is used by abnormally replacing only the battery cell 130.

That is, after a power-on reset, the control unit 111 checks whether the written first encryption code and a second encryption code from a battery cell match with each other, and when they do not match with each other, the control unit 111 prohibits operation of the battery pack 100. Thus, in the case of a newly replaced battery cell, an encryption code of a previous battery cell and an encryption code of a present battery cell do not match with each other. Here, when a voltage of the battery cell after the power-on reset is equal to or greater than a second voltage, the second encryption code of the battery cell is generated after the power-on reset. For example, in the case where a measured voltage of the battery cell after a reset is equal to or greater than about 3.0V, the measured voltage may not be a charge voltage value after normal battery discharge, so that the second encryption code is generated to be compared with the first encryption code that was written before the reset, and then it is determined whether or not to prohibit the operation of the battery pack 100. Here, the prohibition of the operation of the battery pack 100 indicates blowing of the fuse 160 or deletion of firmware stored in the microcomputer 110. For the prohibition of the operation of the battery pack 100, the blowing of the fuse 160 and the deletion of firmware stored in the microcomputer 110 may be performed together or selectively.

The power source unit 114 supplies power to the microcomputer 110, and turns off the microcomputer 110 by a control of the control unit 111. In the present embodiment, when the voltage of the battery cell 130 is equal to or less than the predetermined voltage, the microcomputer 110 is turned off.

The data flash 115 stores data necessary to control the operation of the battery pack 100. In the present embodiment, an encryption code that is generated in the battery cell 130 is stored. The firmware for the operation of the battery pack 100 is also stored.

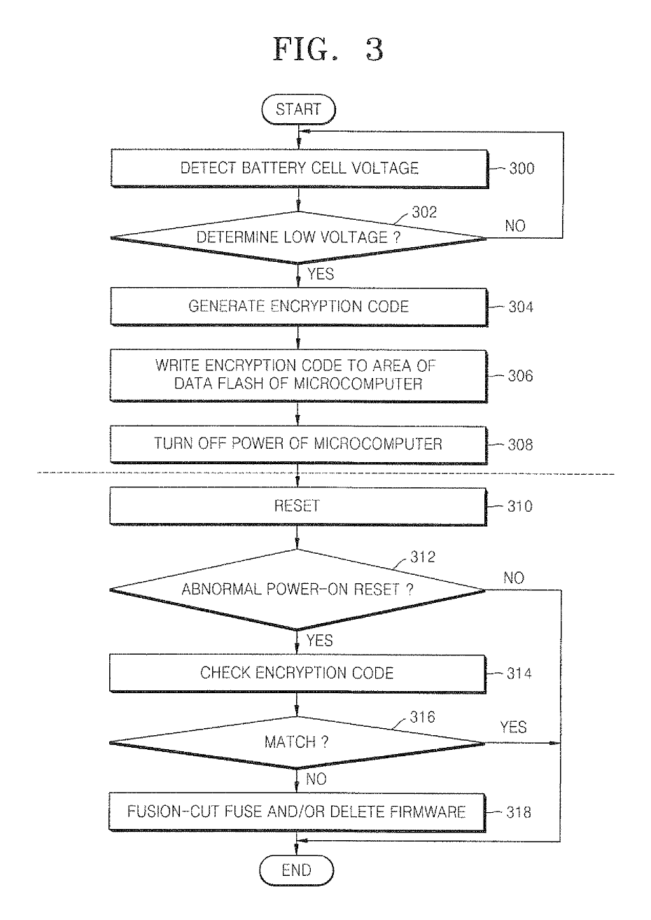

FIG. 3 is a flowchart illustrating a method of preventing cap disassembly or battery cell replacement in a battery pack, according to an embodiment of the present invention.

Referring to FIG. 3, in step 300, a voltage of a battery cell is detected. In step 302, it is determined whether the detected voltage of the battery cell is a low voltage. When the detected voltage of the battery cell is a low voltage, in step 304, an encryption code is generated from information of the battery cell. Here, the information of the battery cell includes a production date, a serial number, a full charge capacity (FCC), and a cycle count. In step 306, the generated encryption code is written to an area of a data flash in a microcomputer.

In step 308, the microcomputer is turned off. In step 310, the microcomputer is reset.

Following reset of the microcomputer, it is determined in step 312 whether the reset is an abnormal power-on reset. Here, a normal power-on reset indicates a case in which the microcomputer was turned off after being in a low voltage state, and after a charge voltage is applied to the battery pack and the battery cell is recharged to a voltage level above a predetermined voltage, e.g., about 3.0V, the microcomputer is reset.

An abnormal power-on reset indicates a case in which, after cap disassembly or a battery cell is forcibly removed or replaced, the charge voltage is applied to the battery pack and the microcomputer is reset. By detecting a voltage of the battery cell after the reset, it is determined as an abnormal power-on reset when the voltage detected is equal to or less than a predetermined voltage, e.g., about 3.0V.

After detection of an abnormal power-on reset, the encryption code written in step 306 is compared in step 314 with an encryption code corresponding to a present battery cell. If it is determined in step 316 that the encryption codes do not match with each other, it is possible to prevent abnormal use when the battery cell has been replaced or the cap has been disassembled, by blowing a fuse and/or deleting firmware in step 318.

If a match is detected in step 316, normal use of the battery pack is permitted.

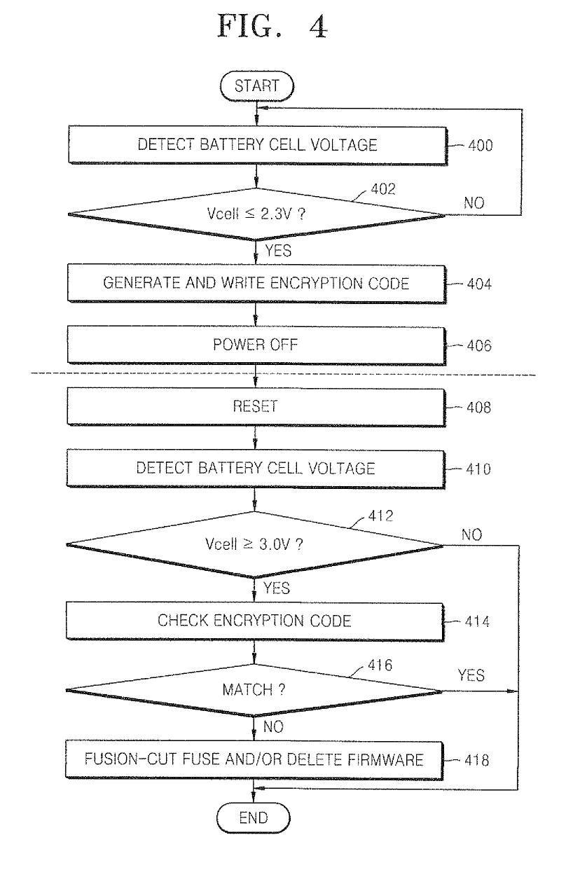

FIG. 4 is a flowchart of a method of preventing cap disassembly or battery cell replacement in a battery pack, according to another embodiment of the present invention.

Referring to FIG. 4, in step 400, a voltage of a battery cell is detected. In step 402, when the voltage of the battery cell is equal to or less than about 2.3V, in step 404, an encryption code is generated according to information about the battery cell, and is written to an area of data flash. In step 406, a microcomputer is turned off.

In step 408, the microcomputer is reset, and in step 410, the a voltage of a battery cell is detected.

In step 412, when the voltage of the battery cell is determined to be equal to or greater than about 3.0V, an encryption code is generated from the battery cell, in step 414, which is then compared in step 416 with the encryption code written to the data flash in step 404. If the encryption codes do not match with each other, it is possible to prohibit operation of the battery pack by blowing a fuse or deleting firmware in step 418.

If a match is detected in step 316, normal use of the battery pack is permitted.

As described above, the battery pack according to the one or more of the above embodiments of the present invention may generate the encryption code and write the encryption code to the data flash when the battery cell is normally discharged. However, when an abnormal power-on reset is performed on the battery cell, the battery pack may check the encryption codes and may delete the firmware and/or blow the fuse when the encryption codes do not match with each other, whereby it is possible to prevent the case in which the cap is disassembled from the battery pack and only replacing the battery cell in the battery pack is replaced.

In addition, other embodiments of the present invention can also be implemented through computer readable code/instructions in/on a medium, e.g., a computer readable medium, to control at least one processing element to implement any above described embodiment. The medium can correspond to any medium/media permitting the storage and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more embodiments of the present invention. The media may also be a distributed network, so that the computer readable code is stored/transferred and executed in a distributed fashion. Furthermore, the processing element could include a processor or a computer processor, and processing elements may be distributed and/or included in a single device.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A battery pack comprising:
a voltage determining unit for determining whether a battery cell voltage of a battery cell is equal to or less than a first voltage;
an encryption code generating unit for generating a first encryption code according to information of the battery cell when the battery cell voltage is equal to or less than the first voltage; and
a control unit for writing the first encryption code to an area of a data flash, checking whether the first encryption code and a second encryption code, generated by using the information of the battery cell after a power-on reset, match with each other, and prohibiting operation of the battery pack when the first encryption code and the second encryption code do not match with each other.

2. The battery pack of claim 1, the voltage determining unit determining whether the battery cell voltage of the battery cell after the power-on reset is equal to or greater than a second voltage;
the encryption code generating unit generating the second encryption code according to the information of the battery cell, when the battery cell voltage is equal to or greater than the second voltage; and
the control unit checking whether the first encryption code and the second encryption code match with each other.

3. The battery pack of claim 1, the control unit blowing a fuse when the first encryption code and the second encryption code do not match with each other.

4. The battery pack of claim 1, the control unit deleting firmware when the first encryption code and the second encryption code do not match with each other.

5. The battery pack of claim 3, the control unit deleting firmware when the first encryption code and the second encryption code do not match with each other.

6. The battery pack of claim 1, the control unit turning off when the battery cell voltage is equal to or less than the first voltage.

7. The battery pack of claim 1, the information of the battery cell comprising at least one of the group consisting of a production date, a serial number, a full charge capacity (FCC), and a cycle count.

8. A battery pack comprising a battery cell and a protective circuit having an analog front end (AFE), a charge-discharge switch, a fuse, and a microcomputer, the microcomputer comprising:
a voltage determining unit for determining whether a battery cell voltage detected by the analog front end is equal to or less than a first voltage;
an encryption code generating unit for generating a first encryption code by using information of the battery cell when the battery cell voltage is equal to or less than the first voltage, the information comprising at least one of the group consisting of a production date, a serial number, a full charge capacity (FCC), and a cycle count of the battery cell; and
a control unit for writing the first encryption code to an area of a data flash, checking whether the first encryption code and a second encryption code, generated by using the information of the battery cell after a power-on reset, match with each other, and prohibiting operation of the battery pack when the first encryption code and the second encryption code do not match with each other.

9. The battery pack of claim 8, the control unit blowing the fuse when the first encryption code and the second encryption code do not match with each other.

10. The battery pack of claim 8, the control unit deleting firmware of the microcomputer when the first encryption code and the second encryption code do not match with each other.

11. The battery pack of claim 9, the control unit deleting firmware of the microcomputer when the first encryption code and the second encryption code do not match with each other.

12. The battery pack of claim 8, the control unit turning off the microcomputer when the battery cell voltage is equal to or less than the first voltage.

13. A method of preventing cap disassembly or battery cell replacement in a battery pack comprising a battery cell and a protective circuit having an analog front end (AFE), a charge-discharge switch, a fuse, and a microcomputer, the method comprising steps of:
determining whether a battery cell voltage of a battery cell is equal to or less than a first voltage;
generating a first encryption code according to information of the battery cell, when the battery cell voltage is determined to be equal to or less than the first voltage;
writing the first encryption code to an area of a data flash;
checking whether the first encryption code and a second encryption code, generated by using the information of the battery cell after a power-on reset, match with each other; and
prohibiting operation of the battery pack, when the first encryption code and the second encryption code do not match with each other.

14. The method of claim 13, the step of checking comprising:
determining whether the battery cell voltage of the battery cell after the power-on reset is equal to or greater than a second voltage;
generating the second encryption code according to the information of the battery cell, when the battery cell voltage is equal to or greater than the second voltage; and
checking whether the first encryption code and the second encryption code match with each other.

15. The method of claim 13, the step of prohibiting comprising deleting firmware of the microcomputer.

16. The method of claim 13, the step of prohibiting further comprising blowing the fuse.

17. The method of claim 15, the step of prohibiting further comprising blowing the fuse.

18. The method of claim 13, the information of the battery cell comprising at least one of the group consisting of a production date, a serial number, a full charge capacity (FCC), and a cycle count.
